(19) United States
(12) Patent Application Publication
(10) Pub. No.: US 2015/0044434 A1
(43) Pub. Date: Feb. 12, 2015

(54) Systems and Methods for Generating Surface Patterns on Composite Building Materials

(71) Applicant: Fiber Composites, LLC, West Warwick, RI (US)

(72) Inventors: Peter Kotiadis, New London, NC (US); Douglas Mancosh, Warwick, RI (US)

(21) Appl. No.: 14/525,501

(22) Filed: Oct. 28, 2014

(51) Int. Cl. B44F 9/02; E04C 2/22; E04C 2/16; B05D 5/06

(52) U.S. Cl. CPC B44F 9/02; B05D 5/06; E04C 2/22; E04C 2/16; B05D 2201/02; B05D 2252/04; E04C 2002/005
USPC 428/207; 427/280

(57) ABSTRACT

Systems and methods are described for generating surface patterns on composite building materials. An example method includes: providing a base polymer; providing a natural fiber; mixing and heating the base polymer and the natural fiber to produce a base mixture including a substantially homogeneous melt blend; extruding the blend through a die to form an extruded profile; and dispensing a pigment from a micro-extruder onto a surface of the extruded profile to form a colored surface pattern.

### FIELD OF THE INVENTION

In general, the invention relates to systems and methods for generating surface patterns on composite building materials.

### BACKGROUND OF THE INVENTION

Many composite deck board products produced today have a surface that mimics the appearance of natural, painted, or stained wood. To achieve such a surface, a composite deck board often includes an earth-tone base color accented with dark or light variegation accents. Due to manufacturing process limitations, however, the variegation accents are generally oriented parallel to a length of the board, in the form of long or short straight lines. Curved or diagonal lines, which appear in natural wood grain, are generally not feasible.

In an extrusion process, variegation is typically achieved by adding colored pellets into an extruder feed-throat, together with materials for the composite core. The colored pellets and the core materials are carried through the extruder and melted together, such that a substantial portion of the colored pellets becomes homogenized with the core materials. The resulting surface variegation is barely visible in some instances.

There is a need for improved systems and methods for generating surface patterns and accents on composite building materials.

### SUMMARY OF THE INVENTION

In one aspect, the invention relates to a method of manufacturing an extruded composite building material. The method includes: providing a base polymer; providing a natural fiber; mixing and heating the base polymer and the natural fiber to produce a base mixture including a substantially homogeneous melt blend; extruding the blend through a die to form an extruded profile; and dispensing a pigment from a micro-extruder onto a surface of the extruded profile to form a colored surface pattern.

In another aspect, the invention relates to a composite building material. The composite building material includes: an extruded profile including a mixture of a base polymer and a natural fiber; and a pigment disposed on a surface of the extruded profile to define a colored surface pattern, the pigment including a blend of a colorant and a carrier polymer, wherein the colored surface pattern includes a line having a directional component perpendicular to an extruded length of the extruded profile.

Herein, unless otherwise noted, the use of one material when describing a particular application, process, or embodiment does not limit the described application, process, or embodiment to the specific material identified. The materials may be used interchangeably, in accordance with the described teachings herein.

### BRIEF DESCRIPTION OF THE DRAWINGS

Other features and advantages of the present invention, as well as the invention itself, will be more fully understood from the following description of the various embodiments, when read together with the accompanying drawings, in which:

FIG. 1 is a photograph of spools of pigmented polymer fiber for use in a micro-extrusion process, in accordance with certain embodiments;

FIG. 2 is a photograph of a micro-extruder system positioned over an extruded profile, in accordance with certain embodiments;

FIGS. 3 and 4 are photographs of pigmented extrudate deposited onto an extruded profile, in accordance with certain embodiments;

FIG. 5 is a schematic, side view of a system for generating surface patterns, in accordance with certain embodiments; and

FIG. 6 is a schematic, top view of the system of FIG. 5, in accordance with certain embodiments.

### DETAILED DESCRIPTION OF THE INVENTION

In certain embodiments, a micro-extruder is used to create accents and patterns on the surface of an extruded composite building material, e.g., to achieve an appearance of natural wood grain and color variation. The micro-extruder applies or dispenses a pigment onto a surface of an extruded profile, and is configured to move with respect to the surface of the profile, to generate one, two, and/or three-dimensional accents and patterns. For example, the patterns may include dots and/or lines that are straight or curved and/or have varying thicknesses. The lines may be oriented in any direction, including perpendicular or diagonal with respect to the extrusion direction of the extruded profile. In general, because the pigments are applied to the surface and not mixed throughout the core, the resulting variegation is more bold and requires less pigment, compared to prior approaches.

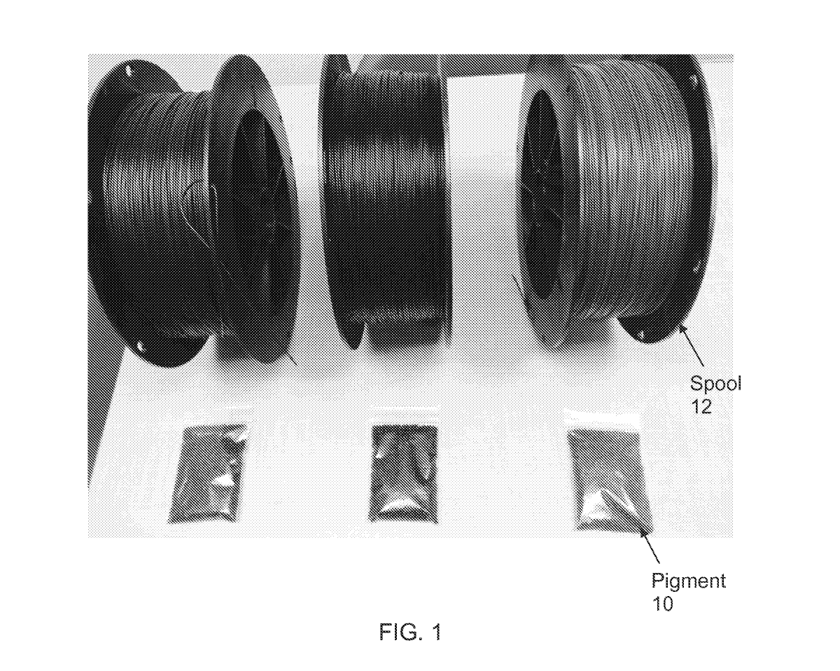

FIGS. 1-6 illustrate an example system and an example method for performing micro-extrusion to achieve surface accents and patterns on a composite building material. Referring to FIG. 1, pigments 10 may be compounded together with UV stabilizers and compatible carrier polymer(s) to form richly colored filament spools 12. The carrier polymer may be or include, for example, polyethylene (e.g., HDPE, LDPE, and/or VLDPE), polypropylene, polyvinylchloride, polyester, nylon, or combinations thereof. The carrier polymer may also include an ionomer, an elastomer (e.g., a propylene-based elastomer and/or EPDM), a lubricant, and/or a compatibilizer (e.g., a maleated polyethylene).

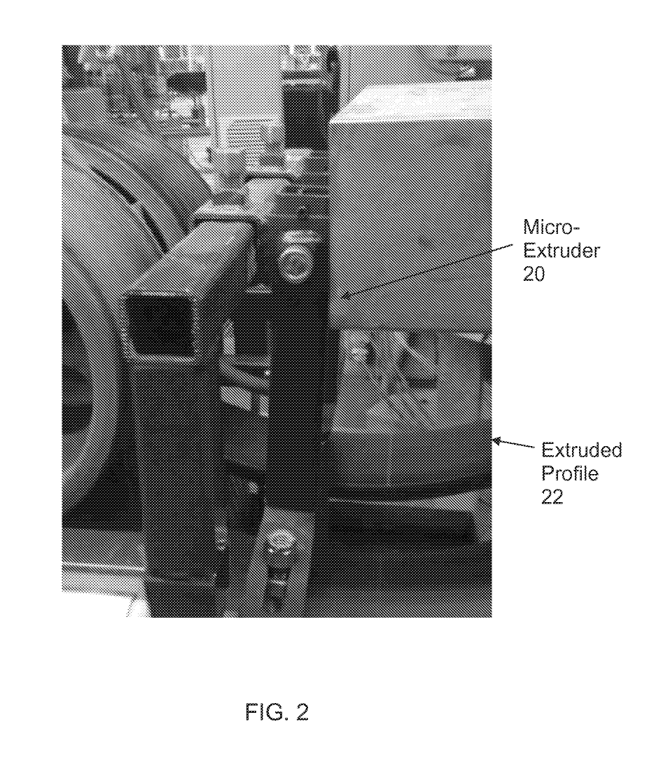

Referring to FIG. 2, colored filament from the filament spools is threaded into one or more micro-extruders 20, which are suspended just outside of a die mounted to a front of an extruder. The micro-extruders are preferably oriented perpendicular to a horizontal plane of an extruded profile or core 22, such that a pigmented extrudate from the micro-extruders 20 is directed toward a top surface of the extruded profile 22.

The micro-extruder 20 is preferably mounted on an x/y/z traversing arm that can move the micro-extruder 20 with respect to the extruded profile 22. For example, the traversing arm may move the micro-extruder 20 along a length of the extruded profile 22 and/or across a width of the extruded profile 22. The traversing arm may also move the micro-extruder 20 closer to or further from a surface of the extruded profile 22. Movement of the micro-extruder 20 relative to the extruded profile 22 allows the micro-extruder 20 to print or deposit the pigmented extrudate in a desired pattern on the extruded profile 22. The micro-extruder 20 may generate, for example, pigmented lines or streaks that are curved or not necessarily aligned with a length of the extruded profile 22. In some examples, the pigmented lines have a directional component that is perpendicular to the length of the extruded profile 22. The traversing arm may also allow the micro-extruder 20 to deposit discrete droplets or dots of pigmented extrudate on different locations of the extruded profile 22, over time. A thickness of the pigmented extrudate on the extruded profile 22 may be varied by, for example, moving the micro-extruder 20 closer to or further from the surface of the extruded profile 22, or by increasing or decreasing a flowrate of the pigmented extrudate from the micro-extruder 20.

The micro-extruders 20 may be controlled using a computer program that increases and decreases the polymer pigment flowrate (e.g., turns the flowrate on and off) and translates the micro-extruder 20 along an x-axis (e.g., across a width of the extruded profile 22), a y-axis (e.g., along a length of the extruded profile 22), and optionally a z-axis (e.g., closer to or further from the extruded profile 22). The micro-extruder 20 preferably deposits the pigmented extrudate streams on a still molten surface of the extruded profile 22, as the extruded profile 22 exits a die of the extruder. The extruded pigment may be applied before any calibration, embossing, and/or cooling of the extruded profile 22.

In general, the micro-extruders 20 are extrusion devices that melt and pump the pigment composition through a die having a desired cross-section. Die diameters for the micro-extruders 20 are typically from about 0.5 mm to about 5 mm, or preferably about 2 mm. Example micro-extrusion devices are obtainable from STRATASYS, Inc., of Eden Prairie, Minn., U.S.A.

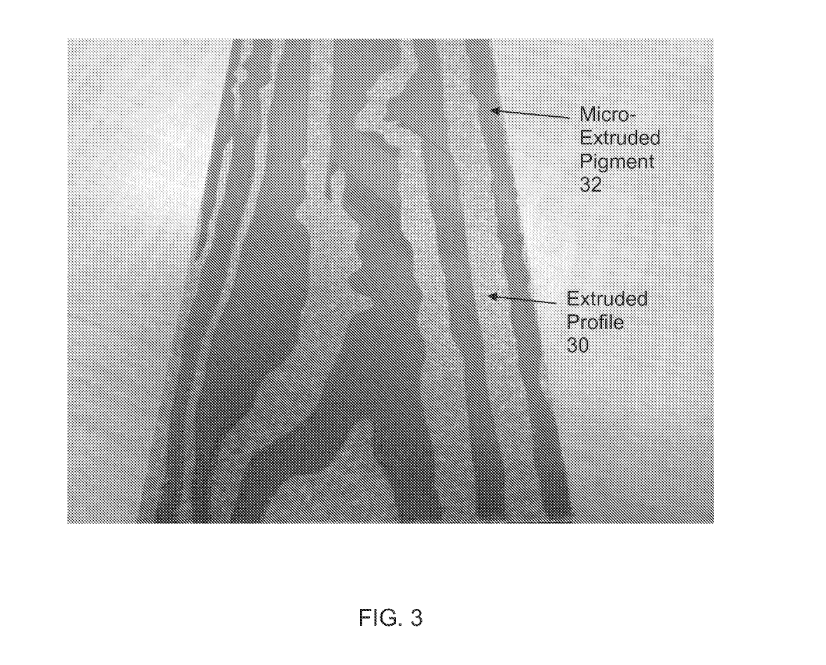

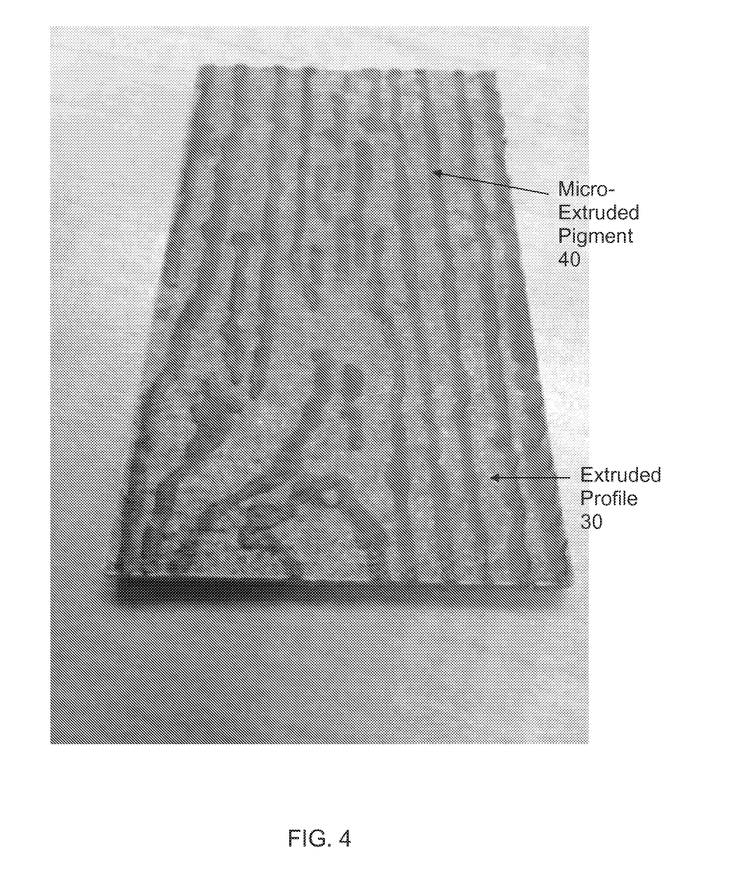

Referring to FIGS. 3 and 4, the highly pigmented extrudate exiting the micro-extruders may be used to create a surface pattern that is multi-directional on an extruded profile 30. For example, the accents may be curved and/or have directional components that run across a width of the extruded profile and/or are parallel to a length of the extruded profile. Each line of micro-extruded pigment 32 shown in FIG. 3 was produced by continuous extrusion from a micro-extruder. By contrast, each line of micro-extruded pigment 40 shown in FIG. 4 was produced by depositing discrete droplets or patches of the pigment from a micro-extruder. Lines or patterns of pigmented extrudate may be generated through continuous extrusion or intermittent extrusion (i.e., droplets or dots of pigment) from one or more micro-extruders.

In some instances, more than one micro-extruder is used to apply the pigmented composition(s). For example, the multiple micro-extruders may be mounted at the same distance from the die that generates the extruded profile. In that case, the micro-extruders may each operate over a separate portion of the width of the extruded profile. Alternatively, multiple micro-extruders may be mounted at different distances from the die used to generate the extruded profile. For example, a first micro-extruder may deposit a first pigmented composition and additional micro-extruders may deposit additional pigmented compositions on or near the first pigmented compositions. The different pigmented compositions may have different colors (e.g., a four color process), allowing for a wide variety of colors and/or surface patterns to be produced.

After deposition of the highly pigmented extrudate from the micro-extruders, the still soft pigmented extrudate may be impressed into the molten surface of the extruded profile using embossing rollers. The embossing rollers may manipulate the pigmented extrudate and introduce surface textures to further refine the surface and achieve a desirable, more natural looking finish.

Table 1 lists example materials and weight percentages that may be used to form the extruded profile. The core polymer may be or include, for example, polyethylene, polypropylene, nylon, polyester, polyvinylchloride, or combinations thereof. A preferred core polymer is polyethylene. Some or all of the core polymer may be obtained from recycled materials, such as waste carpet. The natural fiber is preferably wood flour but may be or include other natural fibers, such as wood chips, wood flakes, sawdust, flax, jute, abaca, hemp, kenaf, and/or rice hulls. The extruded profile may also include one or more additives, such as a colorant, a lubricant, a flame retardant, a compatibilizer, a coupling agent, and a mold inhibitor. An inorganic filler (e.g., calcium carbonate, talc, silica, and/or perlite) may be mixed with the core polymer, the natural fiber, and/or the additive before forming the extruded profile. The extruded profile may be foamed and/or include open or closed cells or voids.

TABLE 1
Example composition of extruded profile

| Component | Min. | Max. | Typical |
|---|---|---|---|
| Core Polymer (wt %) | 1 | 95 | 45 |
| Natural Fiber (wt %) | 1 | 80 | 55 |
| Inorganic Filler (wt %) | 0 | 50 | 0 |
| Additives (wt %) | 0 | 10 | 0 |

Table 2 lists example materials and weight percentages that may be used to form the micro-extruded pigment composition. The base polymer may be or include, for example, polyethylene, polypropylene, nylon, polyester, polyvinylchloride, or combinations thereof, and is preferably the same as or similar to the core polymer, for adhesion purposes. In one example, the base polymer is a high melt flow index (MFI) polyethylene. The pigment may be or include one or more organic or inorganic pigments dispersed or dissolved within the base polymer. The pigment composition may also include natural fiber and/or an additive, such as a lubricant, a compatibilizer, a flame retardant, a compatibilizer, a coupling agent, and a mold inhibitor.

TABLE 2
Example pigment composition

| Component | Min. | Max. | Typical |
|---|---|---|---|
| Base Polymer (wt %) | 1 | 95 | 75 |
| Pigment (wt %) | 5 | 75 | 25 |
| Natural Fiber (wt %) | 0 | 10 | 0 |
| Additives (wt %) | 0 | 10 | 0 |

Table 3 lists example manufacturing process parameters that may be used to generate the extruded profile and the surface patterns described herein. The temperatures of the extruded profile and the micro-extruded pigment listed in the table are temperatures at the respective extruder exits. Coverage of the micro-extruded pigment is given as a weight percentage of the total finished product.

TABLE 3
Example process parameters

| Parameter | Min. | Max. | Typical |
|---|---|---|---|
| Temperature of extruded profile (° C.) | 130 | 200 | 165 |
| Temperature of micro-extruded pigment (° C.) | 150 | 220 | 185 |
| Coverage of micro-extruded pigment (%) | 0 | 10 | 1 |
| Number of micro-extruders | 1 | 10 | 1 |
| Number of pigment colors | 1 | 10 | 1 |
| Micro-extruder die diameter (mm) | 0.5 | 5 | 2 |

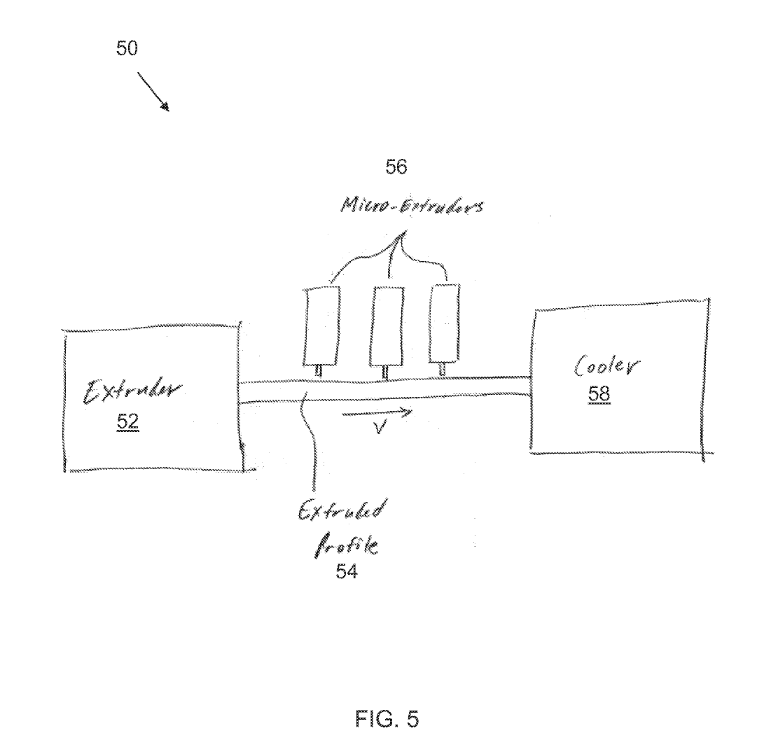

FIG. 5 is a schematic side view of a system 50 for generating surface patterns on an extruded profile, in accordance with certain embodiments of the invention. An extruder 52 produces an extruded profile 54 that travels at a velocity V under a plurality of micro-extruder stations 56. The micro-extruder stations 56 apply one or more pigmented compositions to generate the surface patterns. Once the surface patterns have been generated, the extruded profile is cooled (e.g., in a cooler 58) and/or further processed (e.g., embossed and/or cut into boards).

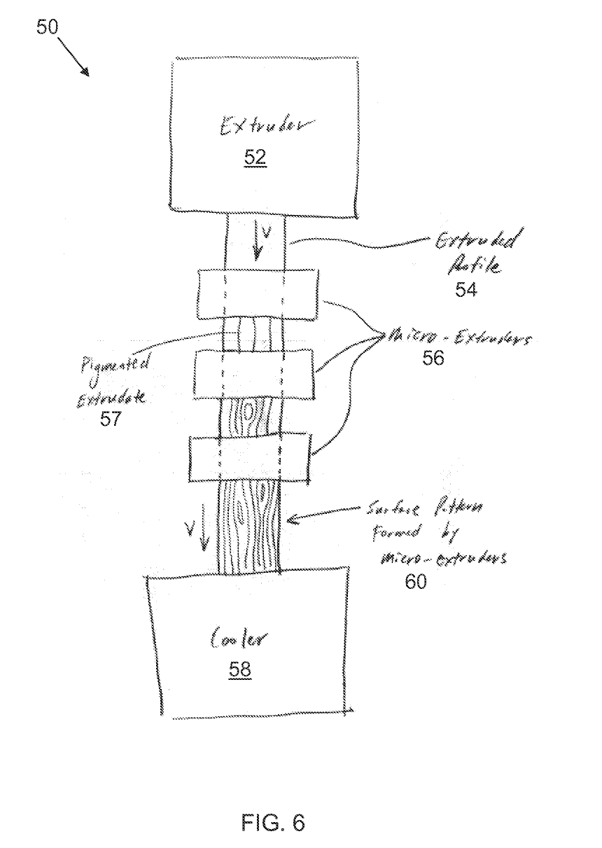

FIG. 6 is a schematic top view showing the system 50 of FIG. 5. As the extruded profile 54 passes underneath the each micro-extruder station 56, more lines or dots of pigment 57 are applied, until a final surface pattern 60 is achieved that may resemble a natural grain pattern, with curved lines and features. Although FIGS. 5 and 6 show three micro-extruder stations, any number of micro-extruder stations 56 may be utilized, and each station 56 may have any number of micro-extruders.

In some instances, the extruded profile includes a capstock or other outer surface layer, and the micro-extruders apply the pigmented composition onto the outer surface layer rather than onto the core. Composite building materials with capstocks, surface layers, and/or colorants are described in U.S. Patent Application Publication No. 2010/0159213, published Jun. 24, 2010, U.S. Patent Application Publication No. 2012/0315471, published Dec. 13, 2012, and U.S. Patent Application Publication No. 2008/0093763, published Apr. 24, 2008, the entire disclosures of which are incorporated by reference herein.

In addition to generating surface patterns on extruded profiles, the micro-extrusion techniques may be used to generate surface patterns on other objects and surfaces, that may or may not be formed by extrusion. For example, the micro-extrusion techniques may be used to generate surface patterns on composite materials formed by pressing and heating, rather than by extrusion. In that case, one or more micro-extruders may be mounted at the exit of a press (e.g., a belt press or a cycle press) and used to generate surface patterns as the pressed product passes under the micro-extruders. Composite building materials formed by extrusion and/or by pressing and heating are described in U.S. Patent Application Publication No. 2012/0077890, published Mar. 29, 2012, the entire disclosure of which is incorporated by reference herein.

In general, compared to prior approaches for adding colored surface accents and patterns, the systems and methods described herein offer several advantages. For example, the x/y/z control of the micro-extruders allows for the creation of computer-controlled rasterized images and patterns to be imparted or reproduced onto the flat profile. Z-axis control of the micro-extruders generally allows for the creation of texture on the profile surface, thereby enhancing appearance and improving the coefficient of friction. Further, by applying pigments to the surface of the extruded profile or core, rather than dispersing pigments throughout the core, the amount of pigment required to produce the surface patterns is reduced, and use of pigments inside the core, where they cannot be seen, is avoided. Additionally, by using a base carrier for the pigmented polymers that is similar to the polymers used to form the core or any capstock on the core, adhesion between the pigmented patterns and the core is optimal. This is in contrast to adhesion problems that may exist with laminated wraps, and/or hot films and foils.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith. For example, the core may be foamed, with or without natural and/or synthetic fibers.

What is claimed is:

1. A method of manufacturing an extruded composite building material, the method comprising the steps of:
providing a base polymer;
providing a natural fiber;
mixing and heating the base polymer and the natural fiber to produce a base mixture comprising a substantially homogeneous melt blend;
extruding the blend through a die to form an extruded profile; and
dispensing a pigment from a micro-extruder onto a surface of the extruded profile to form a colored surface pattern.

2. The method of claim 1, wherein the micro-extruded pigment is dispensed onto the surface when the extruded profile is in a molten state.

3. The method of claim 1, wherein dispensing the pigment comprises moving the micro-extruder relative to the extruded profile.

4. The method of claim 1, wherein dispensing the pigment comprises varying a flowrate of the pigment from the micro-extruder.

5. The method of claim 1, wherein the colored surface pattern comprises a line having a directional component perpendicular to an extruded length of the extruded profile.

6. The method of claim 1, further comprising:
providing an image of a desired colored surface pattern; and
reproducing the desired colored surface pattern on the extruded profile, using the pigment.

7. The method of claim 1, wherein the pigment comprises a blend of a colorant and a carrier polymer.

8. The method of claim 7, wherein the carrier polymer and the base polymer comprise the same polymer.

9. The method of claim 8, wherein the same polymer is selected from the group consisting of polyethylene, polypropylene, polyester, nylon, and polyvinylchloride.

10. An extruded composite building material produced by the method of claim 1.

11. A composite building material comprising:
an extruded profile comprising a mixture of a base polymer and a natural fiber; and
a pigment disposed on a surface of the extruded profile to define a colored surface pattern, the pigment comprising a blend of a colorant and a carrier polymer,
wherein the colored surface pattern comprises a line having a directional component perpendicular to an extruded length of the extruded profile.

12. The composite building material of claim 11, wherein the carrier polymer and the base polymer comprise the same polymer.

13. The composite building material of claim 12, wherein the same polymer is selected from the group consisting of polyethylene, polypropylene, polyester, nylon, and polyvinylchloride.

14. The composite building material of claim 11, wherein the colored surface pattern comprises a curved line of the pigment.

15. The composite building material of claim 11, wherein the composite building material is selected from the group consisting of a deck board, a floor board, a trim board, and siding.

16. The composite building material of claim 11, wherein the colored surface pattern comprises more than one color.
